(19) United States
(12) Patent Application Publication
(10) Pub. No.: US 2016/0072857 A1
(43) Pub. Date: Mar. 10, 2016

(54) ACCESSIBILITY FEATURES IN CONTENT SHARING

(71) Applicant: Microsoft Technology Licensing, LLC, Redmond, WA (US)

(72) Inventors: Julie C. Seto, Duvall, WA (US); Peter Frem, Bothel, WA (US); John R. Sanders, Seattle, WA (US)

(21) Appl. No.: 14/481,803

(22) Filed: Sep. 9, 2014

(51) Int. Cl. H04L 29/06; H04L 29/08

(52) U.S. Cl. CPC H04L 65/403; H04L 67/10

(57) ABSTRACT

A first computing system controls a presentation on a presentation device. The first computing system receives a request to join a presentation, from a second computing system. The first computing system extracts content from the presentation and makes it available to the second computing system in a form in which accessibility settings can be applied to the content, without affecting the visual appearance of the content being presented on the presentation device.

### BACKGROUND

Computer systems are currently in wide use. Some computer systems include sharing functionality that can be used to share content with other computer systems.

By way of example, some computing systems allow users to share, and collaborate on, documents (such as word processing documents, presentation documents, spreadsheet documents, slide shows, etc.) with other individuals or groups. Sharing a presentation can be done, for instance, by a presenter pairing his or her mobile device with a presentation system that includes a relatively large presentation screen. The sharing functionality allows the user to control a presentation, displayed on the relatively large presentation screen, using his or her mobile device. A user may wish to perform this type of sharing, for instance, if the user is a teacher in a classroom, a presenter in a boardroom or meeting room, a presenter in an auditorium, etc.

In these types of presentation and meeting scenarios, it can occur that some members of the audience viewing the presentation have various types of visual impairments. These types of impairments can inhibit the audience members from being able to see the material being presented. For instance, it may be that the auditorium is relatively large, and the presenter is presenting text that may be relatively small. Thus, those at the back of the auditorium may have difficulty reading the text being presented. In another example, one or more audience members may have relatively poor eye sight. Some such users use accessibility systems to enhance the visual presentation of material on their own computing systems. The accessibility systems can enhance the visual presentation by, for instance, changing the contrast of the information being presented, enlarging the information being presented, or changing other formatting of the material being presented.

Mobile devices are also currently in wide use. Mobile devices can include mobile phones, smart phones, handheld computing devices, tablet computing devices, among others. Mobile devices can also include their own accessibility systems.

The discussion above is merely provided for general background information and is not intended to be used as an aid in determining the scope of the claimed subject matter.

### SUMMARY

A first computing system controls a presentation on a presentation device. The first computing system receives a request to join a presentation, from a second computing system. The first computing system extracts content from the presentation and makes it available to the second computing system in a form in which accessibility settings can be applied to the content, without affecting the visual appearance of the content being presented on the presentation device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a presentation architecture.

FIG. 1A is a flow diagram illustrating one example of the operation of the architecture shown in FIG. 1.

FIGS. 2-1 and 2-2 (collectively referred to as FIG. 2) is a block diagram of another example of a presentation architecture in which a content management system, deployed in a remote server environment, is used.

FIG. 2A is a flow diagram illustrating one example of the operation of the architecture shown in FIG. 2.

FIGS. 3-1 and 3-2 (collectively referred to as FIG. 3) is a block diagram of a presentation architecture in which different accessibility versions of content are generated.

FIG. 3A is a flow diagram illustrating one example of the operation of the architecture shown in FIG. 3.

FIGS. 4-1 and 4-2 (collectively referred o as FIG. 4) is a block diagram showing one example of a presentation architecture in which a content management system, deployed in a remote server environment, applies accessibility settings to presentation content, during runtime.

FIG. 4A is a flow diagram illustrating one example of the operation of the architecture shown in FIG. 1.

FIG. 5 is a block diagram showing one example of a presentation architecture, deployed in a cloud computing architecture.

FIGS. 6-8 show various examples of mobile devices.

FIG. 9 is a block diagram showing one example of a computing environment.

### DETAILED DESCRIPTION

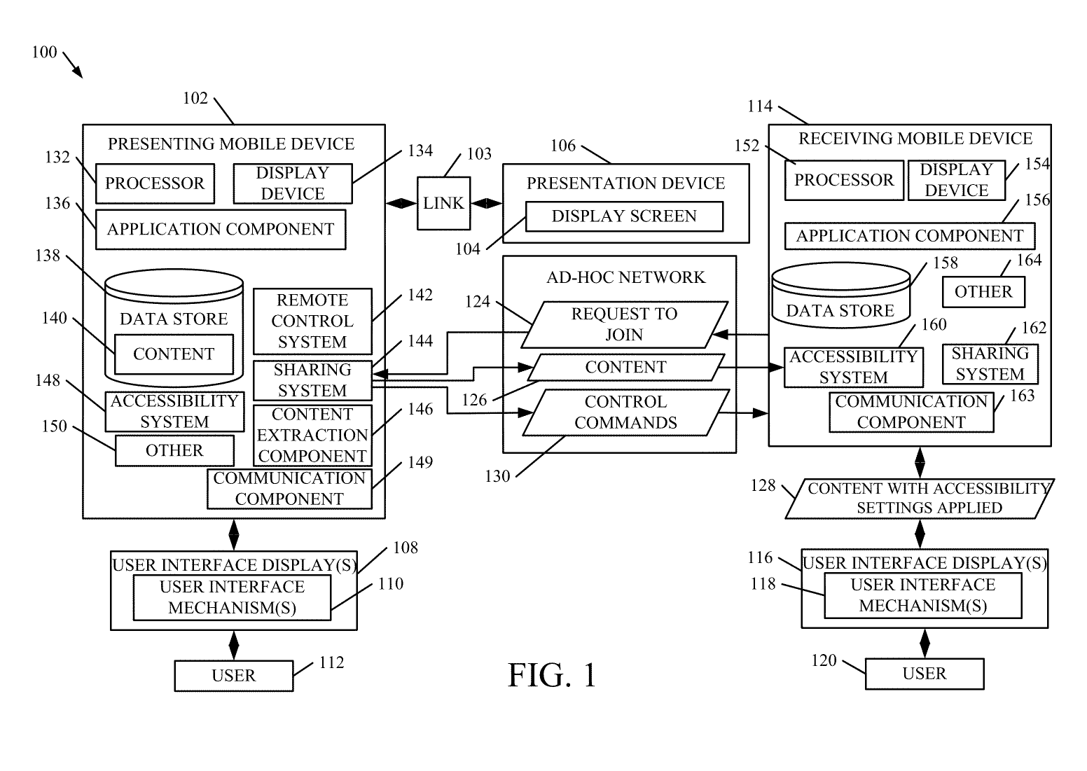

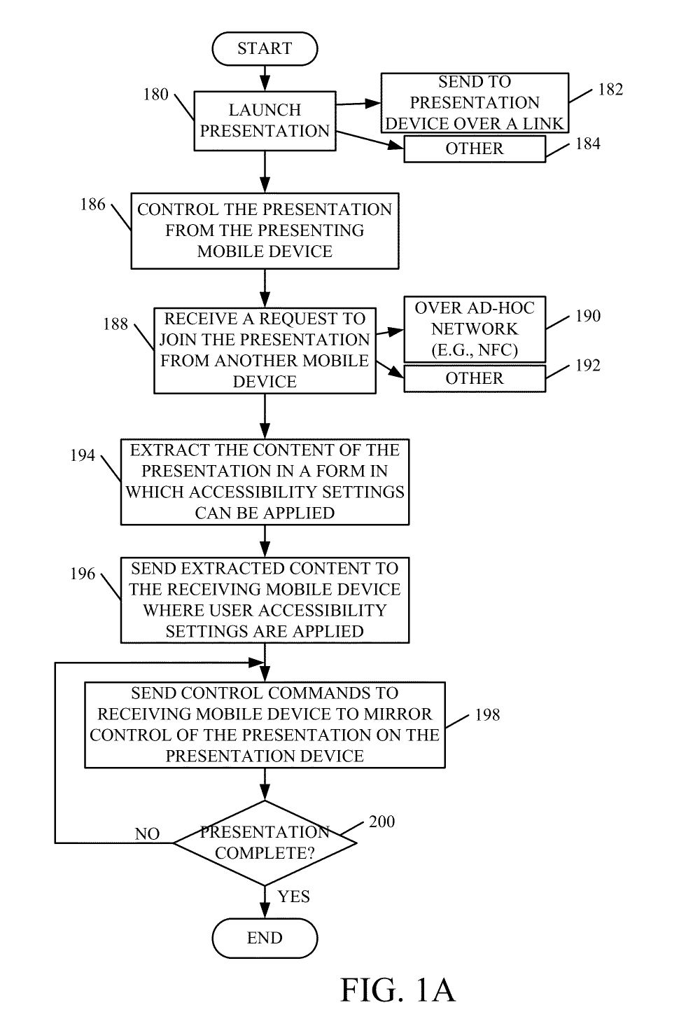

FIG. 1 is a block diagram of one example of a presentation architecture 100. In the example shown in FIG. 1, architecture 100 illustratively includes a presenting mobile device 102 that is presenting and controlling a presentation on a display screen 104 of a presentation device 106 over a link 103. Link 103 can be a near field communication (NFC) link, a wired link, a local area network, or another link. In one example, for instance, presentation device 106 may include a relatively large display screen 104 (such as in a meeting room, an auditorium, etc.). Device 102 is also shown generating user interface displays 108 with user input mechanisms 110 for interaction by user 112. By way of example, the user input mechanisms 110 can be interacted with by user 112 in order to control and manipulate mobile device 102. In the example where user 112 is controlling a presentation on presentation device 106, the user input mechanisms 110 can comprise control inputs that allow the user to interact with them in order to control the presentation (such as moving forward and backward within the presentation, etc.).

Architecture 100 also illustratively includes a receiving mobile device 114 that generates user interface displays 116, with user input mechanisms 118, for interaction by user 120. In the example discussed herein, user 120 is illustratively an audience member who is viewing the presentation being conducted by user 112 on presentation device 106. Thus, in one example, user 120 can interact with user input mechanisms 118 in order to establish an ad hoc network 122 that connects mobile device 114 with mobile device 102. The ad hoc network can be a wide variety of different types of networks, such as a near field communication (NFC) network, a local area network, or another type of network.

In the example described herein, user 120 may have a vision impairment or may otherwise wish to apply accessibility settings to the content of the presentation being displayed on display screen 104. Therefore, user 120 can manipulate mobile device 114 to send a request 124 to join the presentation. In response, mobile device 102 illustratively sends content 126, of the presentation being displayed on display screen 104, to mobile device 114. The content 126 is illustratively sent in a form in which accessibility settings can be applied to the content on mobile device 114. Thus, the content with accessibility settings applied (illustrated by number 128 in FIG. 1) can be provided on user interface displays 116 for review by user 120.

In addition, in one example, the control commands 130 that are used to control the presentation on presentation device 106 are also provided to mobile device 114 so that the content displayed for user 120 mirrors that displayed on display screen 104, except that it also has the accessibility settings for user 120 applied to it. By way of example, if user 112 provides a control command 130 to advance to a next slide in the presentation or to scroll through the presentation content, this control command 130 is also provided to mobile device 114 which will advance to the next slide, or scroll to the desired point within the content, etc.

Before describing the overall operation of architecture 100 in more detail, a number of the other items in FIG. 1 will first be described. In the example shown in FIG. 1, mobile device 102 illustratively includes processor 132, display device 134 on which user interface displays 108 are displayed, application component 136, data store 138 that stores content 140 of the presentation, remote control system 142, sharing system 144, content extraction component 146, accessibility system 148, communication component 149, and it can include other items 150 as well. Processor 132 can illustratively use application component 136 to run applications on mobile device 102. For instance, one of the applications may be a presentation application which application component 136 runs, and which allows user 112 to present the presentation on presentation device 106. Remote control system 142 illustratively allows user 112 to remotely control the presentation on presentation device 106, from mobile device 102. Sharing system 144 illustratively includes functionality that allows mobile device 102 to share content and other information with other mobile devices or other computing devices, such as mobile device 114. Content extraction component 146 illustratively extracts the content 140 from the presentation being displayed at presentation device 106, so that it can be shared with other mobile devices that join the presentation over ad hoc network 122. Component 146 illustratively extracts the content in a form in which accessibility settings can be applied to the content. Accessibility system 148 illustratively allows user 112 to set accessibility settings that are applied to content that is viewed by user 112. Communication component 149 illustratively interacts with communication components on other mobile devices in order to establish ad hoc network 122. Thus, communication component 149 can be a near field communication component, or another type of communication component that can be used to establish network 122.

Like mobile device 102, mobile device 104 also illustratively includes processor 152, display device 154, application component 156, data store 158, accessibility system 160, sharing system 162, communication component 163 and it can include other items 164. These items can, in one example, operate in similar fashion to the corresponding items on mobile device 102.

FIG. 1A is a flow diagram illustrating one example of the operation of architecture 100 (shown in FIG. 1) in allowing user 120 to join the presentation being made by user 112. User 120 can do this to view the content of the presentation with accessibility settings applied to it. FIGS. 1 and 1A will now be described in conjunction with one another.

Mobile device 102 first receives an input from user 112 launching a presentation. This can include user 112 providing inputs to launch a presentation application (such as a slide presentation application or other application) and opening a specific presentation document (e.g., a slide show, a word processing document, etc). Launching the presentation is indicated by block 180 in FIG. 1A. User 112 can also provide inputs to a remote control system 142 which cause remote control system 142 to initiate a communication link 103 with presentation device 106, and to begin sending presentation content to presentation device 106 for display on screen 104. Sending the presentation content to device 106 over link 103 is indicated by block 182. Launching the presentation can include other items as well, and this is indicated by block 184.

User 112 then provides command inputs through user input mechanisms 110 on user interface display 108 in order to control the presentation on display screen 104. For instance, remote control system 142 can generate user input mechanisms that allow the user to advance to a next slide, scroll through a document, or provide a host of other control inputs to control the presentation. Controlling the presentation from the presenting mobile device 102 is indicated by block 186 in FIG. 1A.

At some point, user 120 provides an input on receiving mobile device 114 that causes communication component 163 to establish an ad hoc network 122 with mobile device 102. User 120 then provides inputs to sharing system 162 requesting to join the presentation. For instance, user 120 can provide an input on a user input mechanism 118 which causes sharing system 162 to send the request 124 to join the presentation to sharing system 144 on mobile device 102. Receiving the request from mobile device 114 to join the presentation is indicated by block 188. Receiving it over ad hoc network 122 is indicated by block 190. The request can be received in other ways as well, and this is indicated by block 192.

In response, content extraction component 146 extracts the content 140 of the presentation in a form in which accessibility settings can be applied to it. This is indicated by block 194. By way of example, instead of extracting the content simply as a bitmap (which makes it more difficult to have accessibility settings applied), the content can be extracted in the HTML form describing how the content is to be displayed.

Sharing system 144 then sends content 126 (in a form in which accessibility settings can be applied) to accessibility system 160 on mobile device 114. Accessibility system 116, in turn, automatically applies the user's accessibility settings to the content. Sending the extracted content 126 and applying the accessibility settings on mobile device 114 is indicated by block 196 in FIG. 1A.

As the user 112 provides control commands through remote control system 142 to control the presentation on display screen 104, the control commands 130 are also provided to mobile device 114. In this way, the content being displayed on display device 154 for user 120 mirrors that being displayed on display screen 104 of presentation device 106, for the rest of the audience. One difference, however, is that the content being displayed for user 120 will have the user's accessibility settings applied to it. Providing the control commands to control the content being displayed is indicated by block 198 in FIG. 1A. This continues until the presentation is complete, as indicated by block 200.

It can thus be seen that user 120 can quickly and easily join the presentation and have his or her own accessibility settings applied to the content of the presentation to enhance the user experience in viewing the presentation. However, the presentation content will mirror that for the rest of the audience, so that user 120 need not provide control inputs (such as scroll, advance to a next slide, etc.) in order to follow the presentation. Instead, those control commands will be provided from mobile device 102 to mobile device 114, and the control operations will automatically be performed on mobile device 114. Alternatively, each time the user inputs a control command, the corresponding content is extracted and sent to mobile device 114 from device 102. Therefore, in such an example, the command 130 need not be sent.

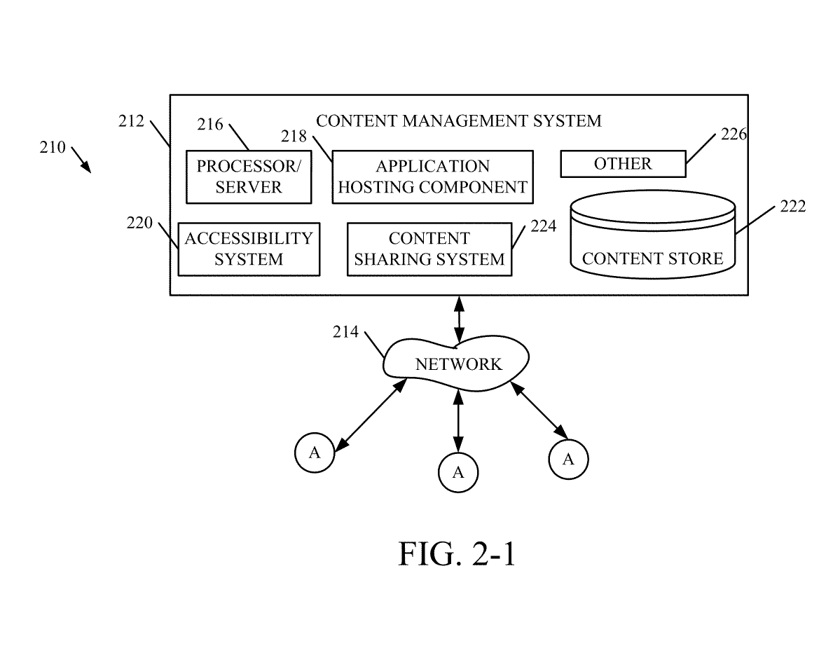

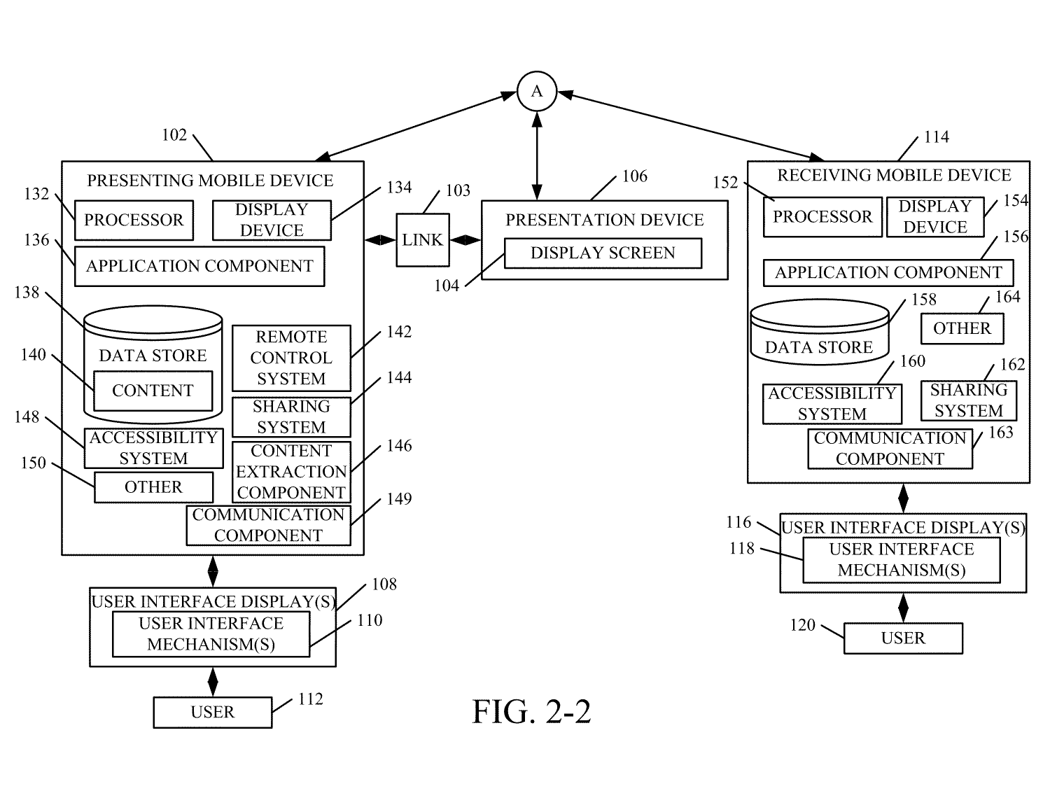

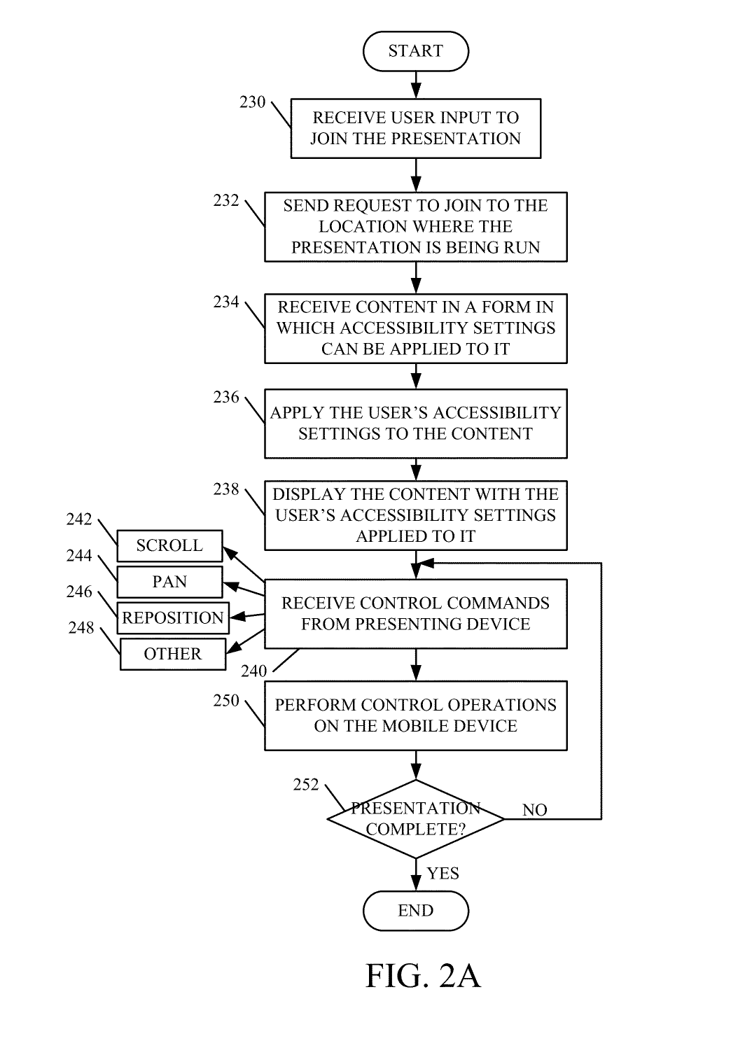

FIGS. 2-1 and 2-2 (collectively referred to as FIG. 2) show a block diagram of another example of a presentation architecture 210. Architecture 210 illustratively includes mobile devices 102 and 114, as well as presentation device 106. Some of the items shown in FIG. 2 are similar to those shown in FIG. 1, and are therefore similarly numbered. In the example shown in FIG. 2, mobile devices 102 and 114 illustratively communicate with content management system 212 over network 214. Network 214 can illustratively be a local area network, a wide area network, a cellular communication network, or a variety of other networks. Users 112 and 120 illustratively access content management system 212, over network 214, in order to create and manage content, such as word processing documents, spreadsheet documents, presentation documents, etc.

Content management system 212 illustratively includes one or more processors or servers 216, application hosting component 218, accessibility system 220, content store 222, content sharing system 224, and it can include other items 226. Processors or servers 216 illustratively run application hosting component 218 to host applications that can be accessed by users 112 and 120. The hosted applications can include, for instance, word processing applications, spreadsheet applications, slide presentation applications, among others. The hosted applications can include client components which reside on mobile devices 102-114, or they can be run independently and accessed by mobile devices 102-114, without a client component.

Content sharing system 224 illustratively provides functionality by which users 112-120 can share various items of content that are created and managed on system 212. Therefore, for instance, content sharing system 224 can be a collaborative system that allows users to collaborate on various items of content.

Accessibility system 220 is also illustratively accessible by users 112-120. They can provide inputs, such as accessibility settings, so that content that is served to the users 112-120 will have the users' accessibility settings applied to it, where desired.

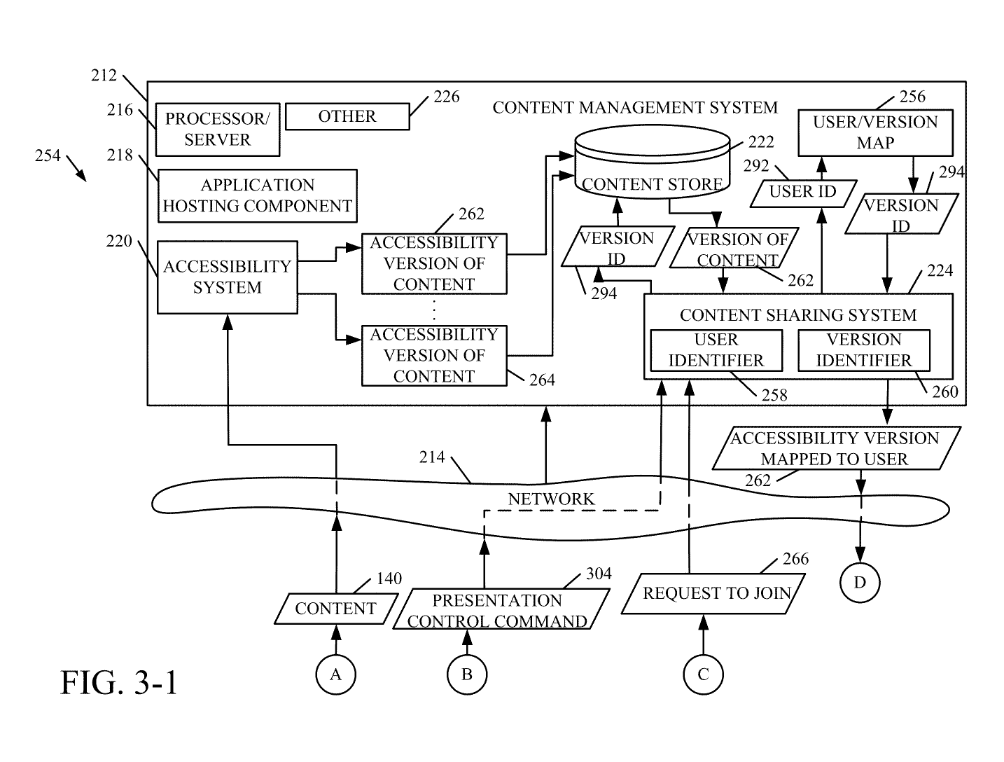

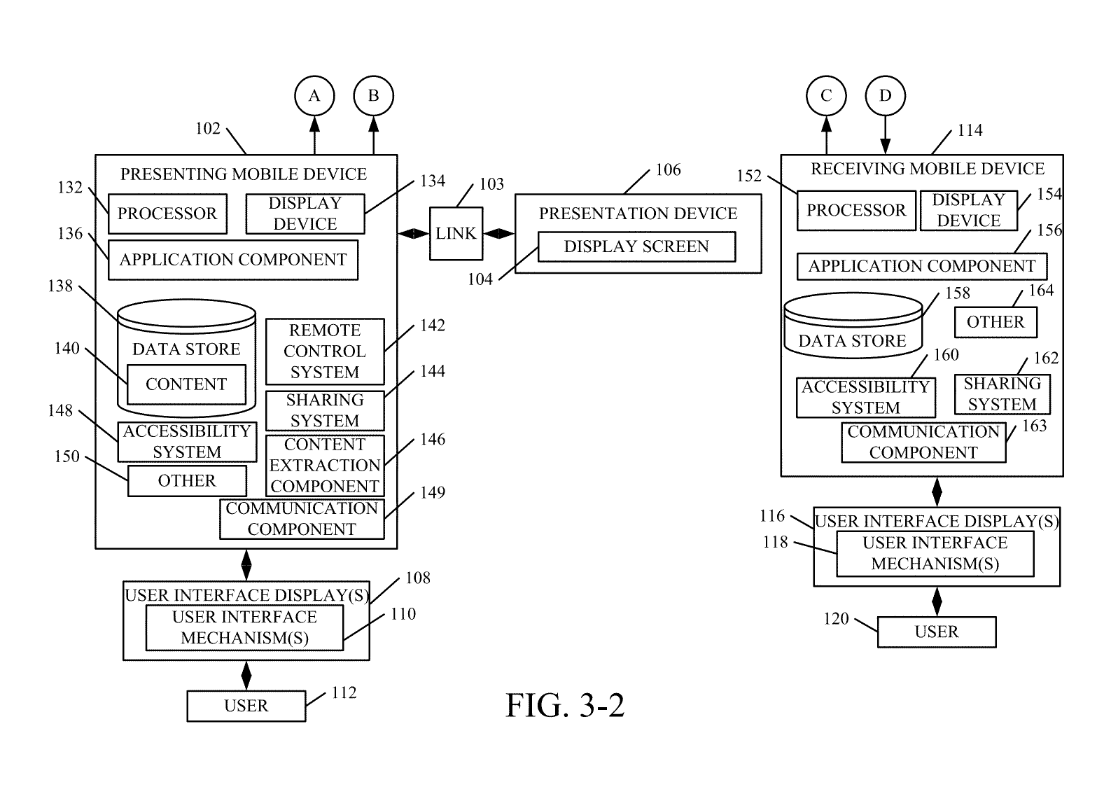

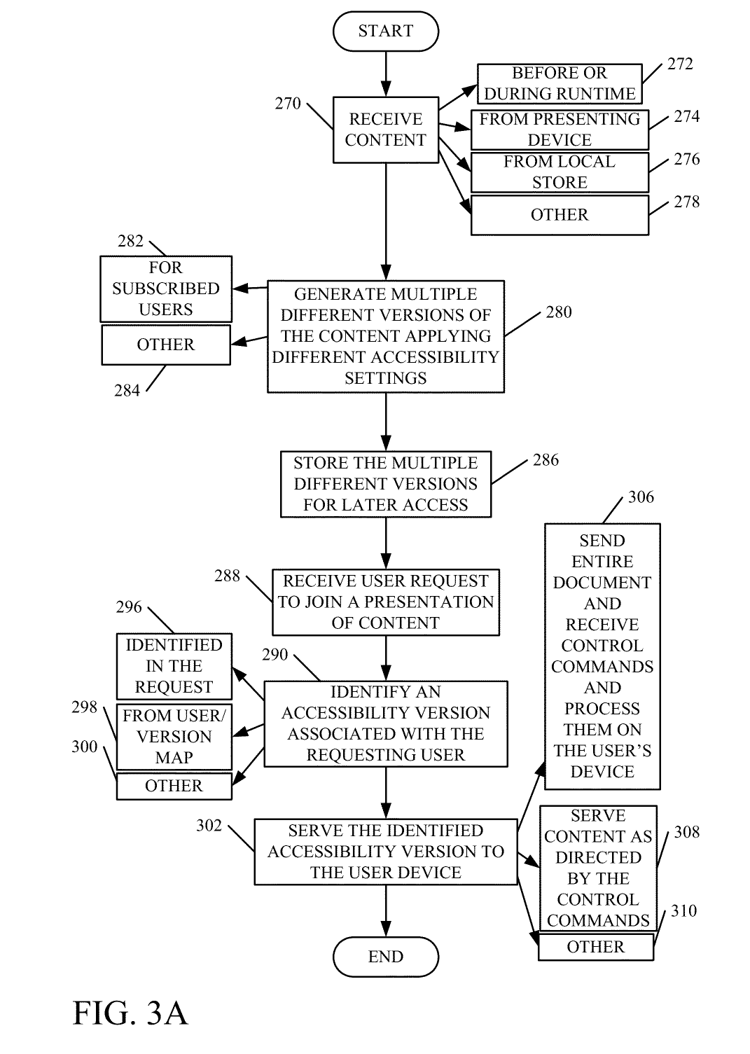

A number of examples of how content management system 212 can enable user 120 to view content with the accessibility settings of user 120 applied to it are described in greater detail below. Briefly, however, in one example, content management system 212 can receive the content of the presentation from mobile device 102 and generate a number of different versions of that content, with the different accessibility settings of the different users applied to it. Those versions can be stored in content store 222. When user 120, for instance, logs in through content sharing system 224 to join the presentation being given by user 112 with mobile device 102, the command control signals input by user 112 can be provided to content management system 212 so that system 212 serves the particular version of the content to user 120, that has the accessibility settings of user 120 applied to it. One example of this is described in greater detail below with respect to FIG. 3.

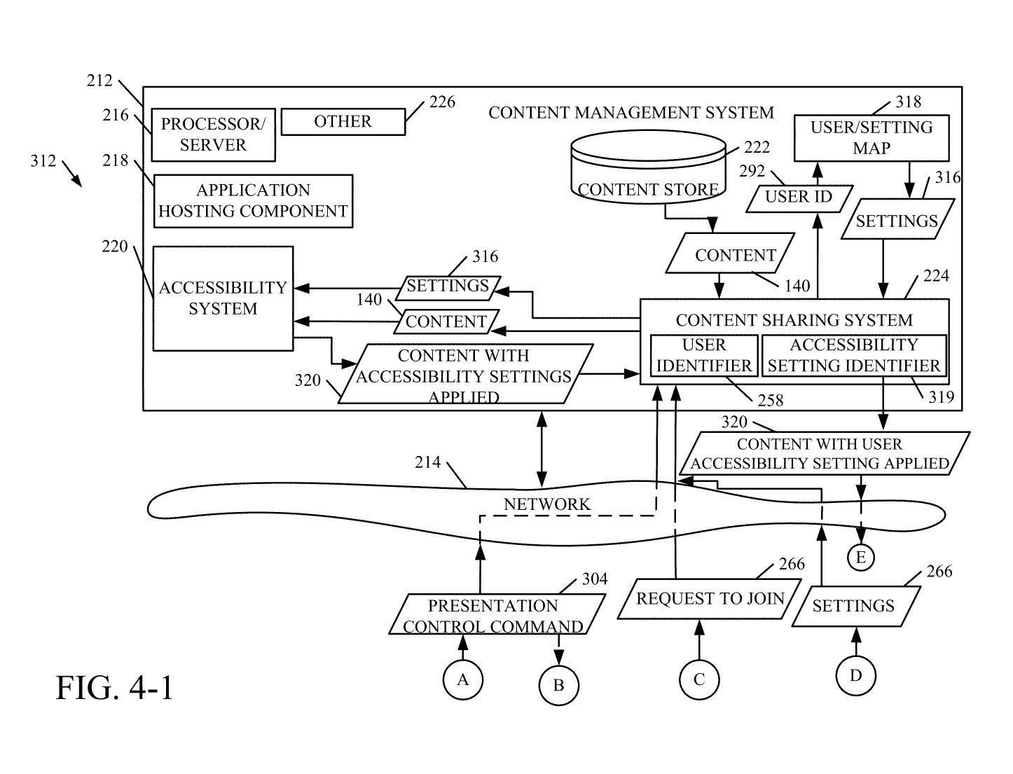

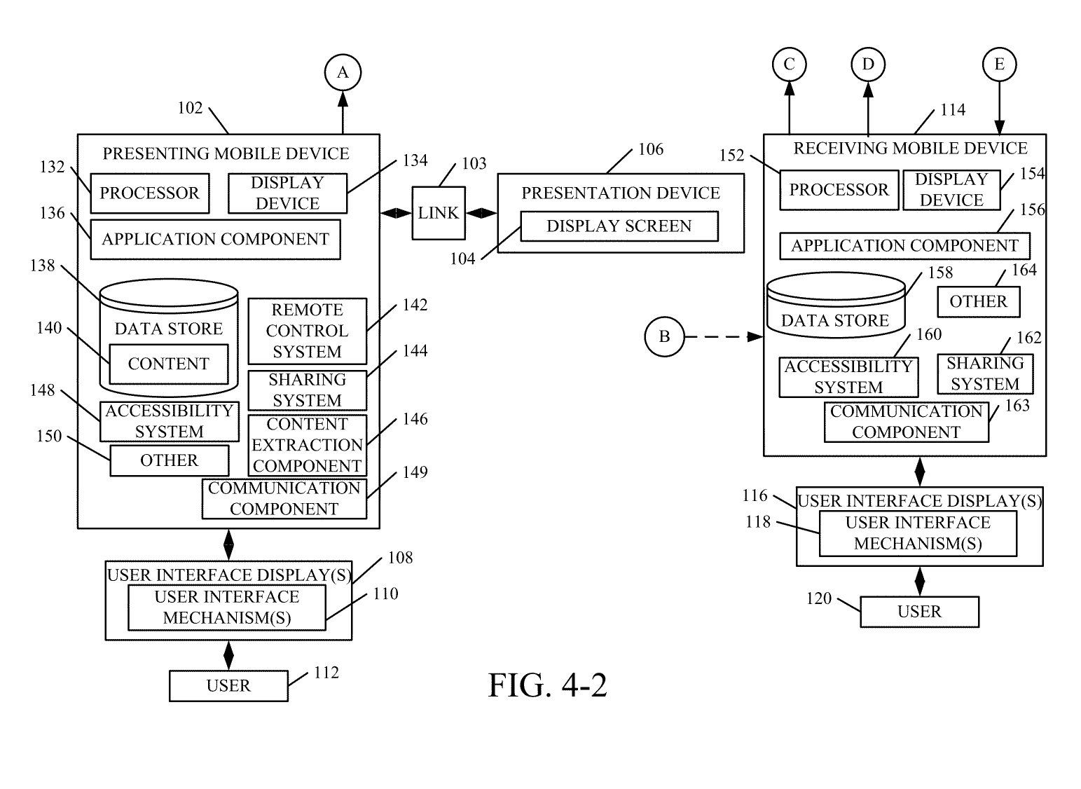

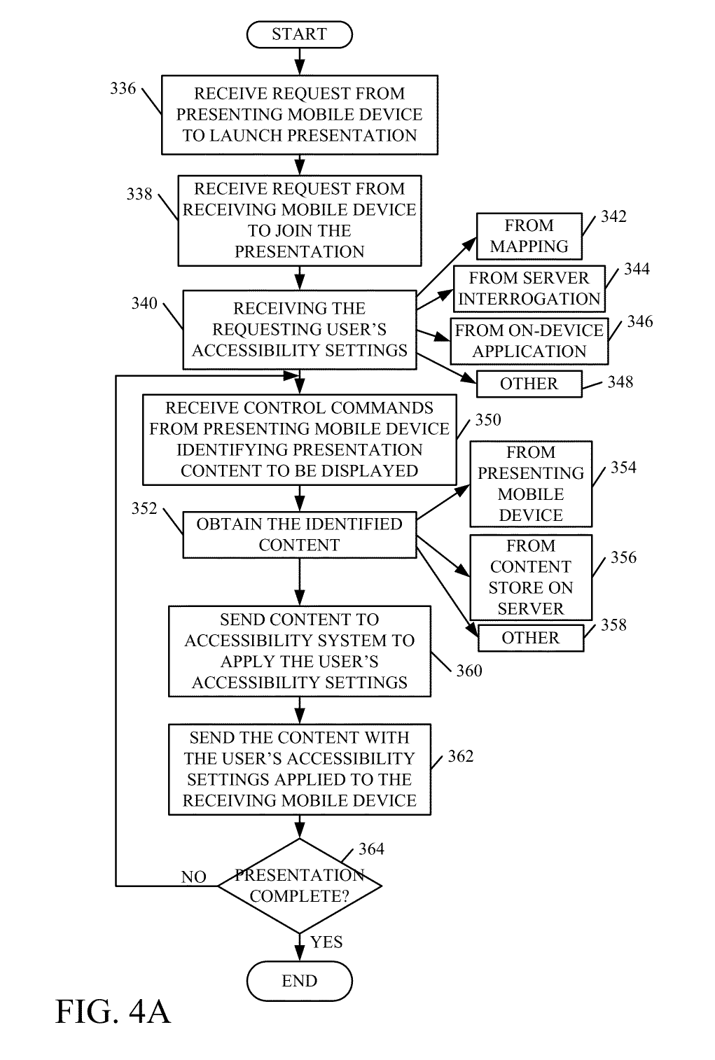

In another example, application hosting component 218 can host the presentation application that is used to display the presentation content on presentation device 106. Therefore, during runtime, application hosting component 218 can, at the same time, provide the content that is displayed on presentation device 106, and also generate a version of the content, with the accessibility settings corresponding to user 120 applied to it, and serve that content to user 120 through mobile device 114. This is described in greater detail below with respect to FIG. 4. Before describing the examples in FIGS. 3 and 4 in more detail, a more general description will first be provided for the sake of example.

FIG. 2A is a flow diagram illustrating one example of the operation of architecture 210, shown in FIG. 2, in allowing user 120 to view the content of the presentation being made by user 112, with the accessibility settings of user 120 applied to that content. It is first assumed that user 112 is currently making a presentation. Therefore, the presentation content is displayed on display device 104 of presentation system 106. User 112 illustratively uses remote control system 142 to provide the control commands to control the presentation.

At some point, user 120 illustratively provides an input mobile on device 114 indicating that user 120 wishes to join the presentation. Receiving the user request input at mobile device 114 is indicated by block 230 in FIG. 2A. Mobile device 114 then sends the request to join the presentation to the location where the presentation is being run. For instance, if it is being run through content management system 212, the request is sent there. If it is being run from mobile device 102, the request is sent there. Sending the request to join the presentation to the particular location where the presentation is being run is indicated by block 232 in FIG. 2A.

In one example, either mobile device 102 or content management system 212 extracts the content of the presentation, as it is being presented, and sends the extracted content to mobile device 114. Receiving the content in a form in which accessibility settings can be applied to it is indicated by block 234.

Once mobile device 114 has received the content in that form, accessibility system 160 illustratively applies the accessibility settings, that were previously entered by user 120, to the content. This is indicated by block 236.

The content is displayed on display device 154 of mobile device 114, with the user's accessibility settings applied to it. This is indicated by block 238.

Mobile device 114 then eventually receives control commands from presenting device 102. This is indicated by block 240. For instance, the control commands can be received at mobile device 114 over an ad hoc network established between mobile devices 102 and 114 (as described above with respect to FIG. 1). In another example, mobile device 102 can send the control commands to content management system 212, where they are forwarded to mobile device 114 over network 214. The control commands can be sent in a variety of other ways as well. In one example, the commands are used to control the presentation. Therefore, they can be scroll commands 242, pan commands 244, reposition commands 246, or other commands 248. Other commands can include, for instance laser pointer commands and annotations on the presentation, such as notes or inking, among others. Scroll command 242 illustratively scrolls the content of the presentation. Pan command 244 pans the content. Reposition command 246 repositions the currently displayed content (such as jumps to a non-sequential slide, etc.) within the overall presentation.

Mobile device 114 then performs the control operations corresponding to the received control commands on mobile device 114, so that the content displayed on display device 154 of mobile device 114 mirrors that being displayed on display screen 104 of presentation device 106, except that the content on mobile device 114 has the user's accessibility settings applied to it. Performing the control operations is indicated by block 250 in FIG. 2A. Processing continues in this way as long as the presentation is being made.

At some point, the presentation will be completed. This is indicated by block 252 in FIG. 2A.

FIGS. 3-1 and 3-2 (collectively referred to as FIG. 3) show another example of a presentation architecture 254. A number of the items described above with respect to FIG. 2 are similar to those shown in FIG. 3, and they are similarly numbered. FIG. 3 shows that content management system 212 can also illustratively include a user/version map 256, and that content sharing system 224 can illustratively include user identifier component 258 and version identifier component 260. Before describing one example of the operation of the architecture shown in FIG. 3, a brief overview will be provided.

Presenting mobile device 102 first illustratively provides the content 140 of a presentation to content management system 212, over network 214. Accessibility system 220 then makes a plurality of different accessibility versions of the content (indicated by blocks 262-264 in FIG. 3). Those versions illustratively include the content 140 with the accessibility settings corresponding to a plurality of different users applied to it. Those different versions 262-264 are then stored in content store 222. When the presentation is being made, user 120 illustratively provides a request to join the presentation 266, to content sharing system 224, over network 214. User identifier 258 identifies user 120 from the request 266, and version identifier 260 accesses user/version map 256 to identify the particular accessibility version 262-264 that has the accessibility settings corresponding to user 120 applied to it. It then retrieves that version (e.g., version 262) from content store 222, and sends it to mobile device 114 (again, illustratively through network 214) where it is displayed on display device 154 for user 120.

FIG. 3A is a flow diagram illustrating one example of the operation of architecture 254, in more detail. FIGS. 3 and 3A will now be described in conjunction with one another. Accessibility system 220 in content management system 212 first receives the presentation content 140 from mobile device 102, or from another source. For instance, if user 112 has generated the presentation content on content management system 212, then accessibility system 220 can receive the content from content store 222. If user 112 has generated the content on another system, accessibility system 220 can receive the content from that system. Receiving the presentation content, in general, is indicated by block 270 in FIG. 3A. Receiving the content information from mobile device 102 is indicated by block 274, and receiving it from local store 222 is indicated by block 276. Receiving it in other ways is indicated by block 278. In one example, accessibility system 220 receives the content 140 either before the presentation, or during runtime of the presentation. This is indicated by block 272.

Accessibility system 220 then generates multiple different versions 262-264 of the presentation content 140, by applying the different accessibility settings for various different users. This is indicated by block 280. In one example, for instance, users subscribe to have accessibility versions created for them. This is indicated by block 282. In another example, accessibility system 220 can identify the particular users that will be in the audience (e.g., in the audience of the presentation, in the meeting where the presentation is being made, or otherwise) and generate accessibility versions of the presentation content for all of the attendees that have provided accessibility settings. The attendees can be identified by accessing a meeting notice on a calendar of user 112 or in other ways. Generating the multiple different versions in other ways is indicated by block 284.

Accessibility system 220 then illustratively stores the different accessibility versions 262-264 on content store 222. This is indicated by block 286 in FIG. 3A.

At some point, either during the presentation, or beforehand, system 212 illustratively receives a request to join the presentation 266 from mobile device 114. This is indicated by block 288.

Content sharing system 224 then illustratively identifies an accessibility version 262-264 associated with the requesting user 120. This is indicated by block 290. This can be done in a wide variety of different ways. For instance, user identifier 258 illustratively identifies the user. Such identifying information can illustratively be contained in the request 266. Version identifier 260 can illustratively access user/version map 256 using the user identifying information 292 to obtain a version identifier 294 that identifies the particular accessibility version 262-264 which should be provided to user 120. In the example described herein, it will be assumed that version 262 is the version that is to be sent to user 120. Content sharing system 224 then illustratively accesses content store 222, using the version identifier 294 to obtain the version 262 of the content that is to be sent to user 120. Identifying the user ID in the request 266 is indicated by block 296 in FIG. 3A. Accessing the version identifier from a user/version map 256 is indicated by block 298. Of course, it will be appreciated that content sharing system 224 can identify the accessibility version to be provided to the requesting user 120 in other ways as well, and this is indicated by block 300.

Content management system 212 then serves the identified accessibility version 262 to the user device 114. In one example, this is illustratively done over network 214. This is indicated by block 302. This can also be done in a wide variety of different ways. For instance, system 212 can send the entire document (with the accessibility settings applied to it) to mobile device 114, all at once, and mobile device 102 can provide control commands 304 to mobile device 114, where they are processed. In this way, mobile device 114 controls display of the content based upon the control commands 204 so that the content displayed on display device 154 mirrors that displayed at presentation device 106, except that it has the user's accessibility settings applied to it. Sending the entire document from system 212 to mobile device 114, and then receiving the presentation control commands 304 on mobile device 114, is indicated by block 306 in FIG. 3A.

In another example, system 212 illustratively serves the content during runtime. Therefore, system 212 receives the presentation control commands 304 and serves content to mobile device 114, based upon those commands. This may be the case, for instance, where application hosting component 218 is hosting the presentation application that is being used to generate the presentation. Serving the content as directed by the control commands 304 from content management system 212, is indicated by block 308 in FIG. 3A. The content can be served to mobile device 114 in other ways as well, and this is indicated by block 310.

FIGS. 4-1 and 4-2 (collectively referred to as FIG. 4) show a block diagram of another example of a presentation architecture 312. Some of the items shown in FIG. 4 are similar to those shown in FIG. 3, and are similarly numbered. FIG. 4 shows that content management system 212 also illustratively includes a user/setting map 318 and accessibility setting identifier 319. Map 318 maps individual users of architecture 112 to a set of accessibility settings that are to be applied for that user. Thus, user 120 illustratively provides the request 266 to join the presentation to content sharing system 224. User identifier 258 in sharing system 224 obtains user identifier information 292 that identifies the particular user 120, from request 266, and provides that to accessibility setting identifier 319. Accessibility setting identifier 319 provides user identifier information 292 to user/setting map 318 to identify the particular accessibility settings 316 corresponding to this user.

In the example shown in FIG. 4, the presentation is illustratively run from content management system 212. Therefore, user 112 provides presentation control commands 304 (through remote control system 142) to content sharing system 224 (through network 214). Processor or servers 216 illustratively run application hosting component 218 to provide content, in runtime to presentation device 106 and to mobile device 114. The presentation control commands 304 identify the particular content which is to be displayed during the presentation (e.g., on display screen 104). Therefore, when content sharing system 224 receives a command 304, it obtains that content (e.g., content 140) from content store 222 and provides it to accessibility system 220. Content sharing system 224 provides the settings 316 that it received from user setting map 318 to accessibility system 220 as well. Accessibility system 220 applies the settings 316 to the content 140 and returns the content with the accessibility settings applied, as indicated by 320 in FIG. 4. Sharing system 224 then provides the content with the user's accessibility settings applied to mobile device 114, where they are displayed on display device 154.

FIG. 4A is a flow diagram illustrating one example of the operation of architecture 312. FIGS. 4 and 4A will now be described in conjunction with one another. It is first assumed that user 112 wishes to launch a presentation that will be run from content management system 212. In that case, the presentation content is stored in content store 222, and processor or server 216 launches an application hosting component which hosts the presentation application. In order to launch the presentation, user 112 illustratively provides a suitable user input with user input mechanism 110.

Mobile device 102, in turn, provides a request through network 214 to content management system 212, requesting content management system 212 to launch the presentation. Receiving the request from mobile device 102 to launch the presentation is indicated by block 336 in FIG. 4A. In return, content management system 212 launches the presentation and begins providing content either to mobile device 102, which provides it to presentation device 106, or directly to presentation device 106.

At some point, user 120 illustratively controls mobile device 114 to send request 266 to join the presentation. Receiving the request from mobile device 114 to join the presentation is indicated by block 338 in FIG. 4A.

Content sharing system 224 then obtains the requesting user's accessibility settings 316. This is indicated by block 340. As briefly discussed above, this can be done by having user identifier 258 identify user 120 and having accessibility setting identifier 319 obtain settings 316 from map 318, based upon the user ID information 292. Obtaining the user's settings by accessing map 318 is indicated by block 342 in FIG. 4A.

In another example, server 216 interrogates mobile device 114, once it receives a request 266. It illustratively interrogates accessibility system 160 in mobile device 114, to obtain the user's accessibility settings 316. Obtaining the accessibility settings for user 120 by interrogating mobile device 114 is indicated by block 344 in FIG. 4A. In another example, an application running on mobile device 114 can automatically provide the accessibility settings for user 120, along with request 266. This is indicated by block 346 in FIG. 4A. Of course, system 212 can obtain the accessibility settings for user 120 in other ways as well, and this is indicated by block 348.

Content sharing system 224 also illustratively receives presentation control commands 304 identifying presentation content to be displayed on display screen 104 of presentation device 106. This is indicated by block 350. Content sharing system 224 then obtains the identified content 140. This is indicated by block 352. It can obtain the content from the presenting mobile device 102, as indicated by block 354. It can obtain the content from content store 222, as indicated by block 356. It can obtain the identified content in other ways as well, as indicated by block 358.

Content sharing system 224 then sends the identified content 140 to accessibility system 220, along with the user's accessibility settings 316, so system 220 can apply settings 316 to content 140. This is indicated by block 360 in FIG. 4A. Content sharing system 224 then receives the content with the accessibility settings applied (indicated by 320) and sends that to device 114. This is indicated by block 362. This processing continues, with system 212 receiving additional control commands 304, obtaining additional content, having accessibility system 220 apply the user's accessibility settings to the identified content, and sending that content with the accessibility settings applied to mobile device 114, until the presentation is complete. This is indicated by block 364.

It can thus be seen that the operation of the entire presentation architecture is improved. Any audience members viewing the presentation can easily request to join the presentation and view the presentation content with the user's own specific accessibility settings applied. This can be done in a variety of different ways.

For instance, it can be done on the receiving mobile device 114, itself. The mobile device 114 can receive content that is extracted and sent to it in a form in which the accessibility settings can be applied to it. This can be done at runtime so that the content being displayed on device 114 mirrors that on presentation device 106, except that it has accessibility settings applied to it.

The accessibility settings can also be applied in content management system 212, regardless of whether content management system 212 is running the presentation application. For instance, accessibility system 220 can pre-generate a plurality of different versions of the content, with different user accessibility settings applied. Then, when a user requests to join the presentation, the version of the presentation with that user's accessibility settings applied is sent to the receiving mobile device 114 for that user. Mobile device 114 also receives the control commands from presenting mobile device 102 so that, again, the content displayed for user 120 by mobile device 114 mirrors that displayed in presentation device 106, except the version displayed has the user's accessibility settings applied.

In addition, system 212 can apply the accessibility settings, on the fly. When a user 120 requests to join the presentation, system 212 can interrogate the user's mobile device 114 to obtain the user's particular accessibility settings. They can then be applied to the content of the presentation, on the fly, as presentation control commands 304 are received. The content generated in this way, on the fly, can be sent to mobile device 114 so that, again, the content displayed on mobile device 114 mirrors that displayed on presentation device 106, except that it has the user's accessibility settings applied to it.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

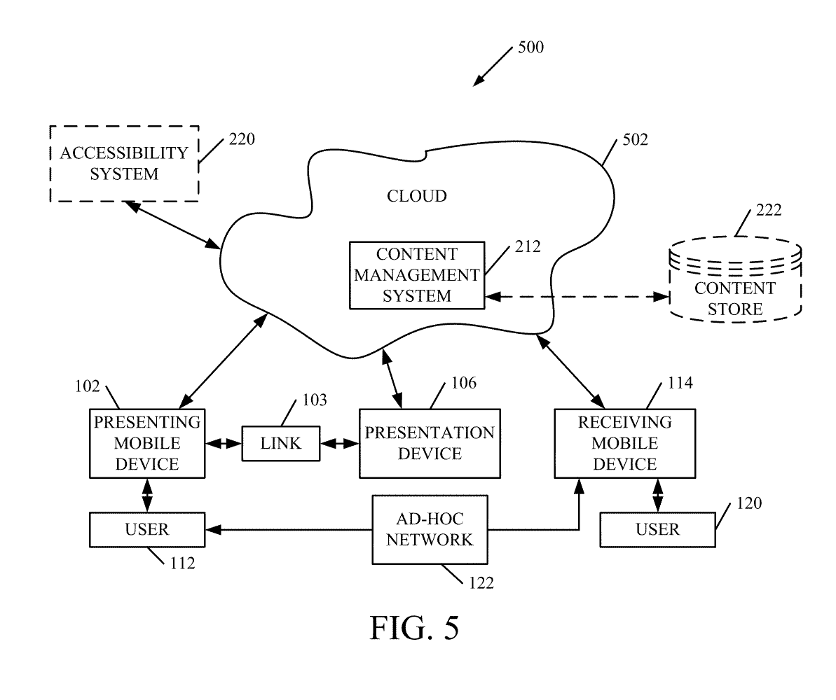

FIG. 5 is a block diagram of the architectures described above, except that the elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in previous Figures and they are similarly numbered. FIG. 5 specifically shows that some items are located in cloud 502 (which can be public, private, or a combination where portions are public while others are private). Therefore, users 112 and 120 use mobile devices 102-114 to access those systems through cloud 502.

FIG. 5 also depicts another example of a cloud architecture. FIG. 5 shows that it is also contemplated that some elements of the architectures are disposed in cloud 502 while others are not. By way of example, data store 222 can be disposed outside of cloud 502, and accessed through cloud 502. In another example, accessibility system 220 can also be outside of cloud 502. Regardless of where they are located, they can be accessed directly by devices 102-114, through a network (either a wide area network or a local area network), they can be hosted at a remote site by a service, or they can be provided as a service through a cloud or accessed by a connection service that resides in the cloud. All of these architectures are contemplated herein.

It will also be noted that the architectures described above or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

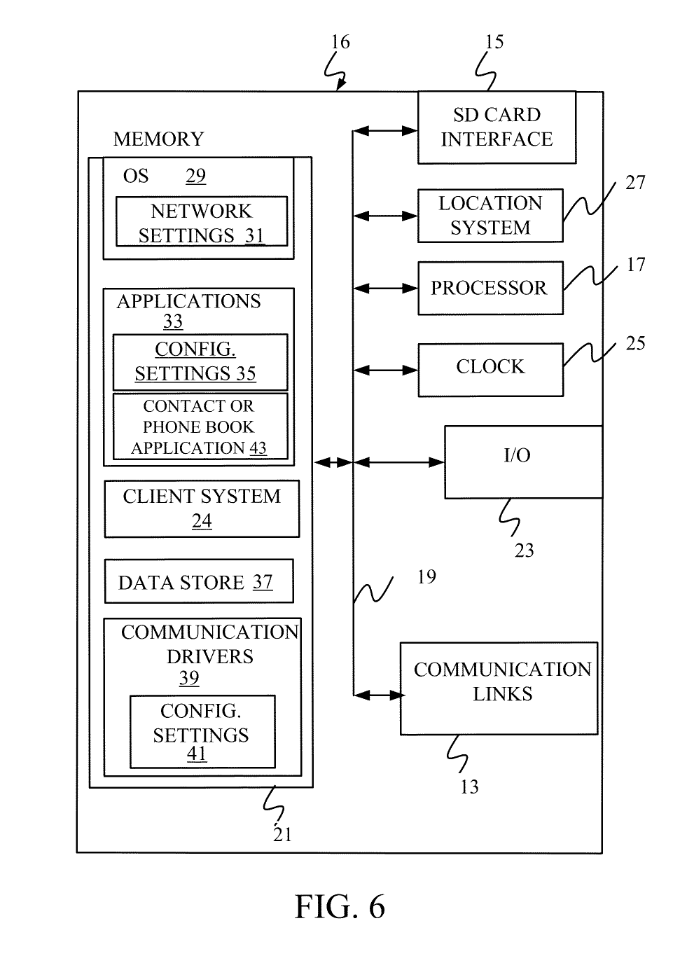

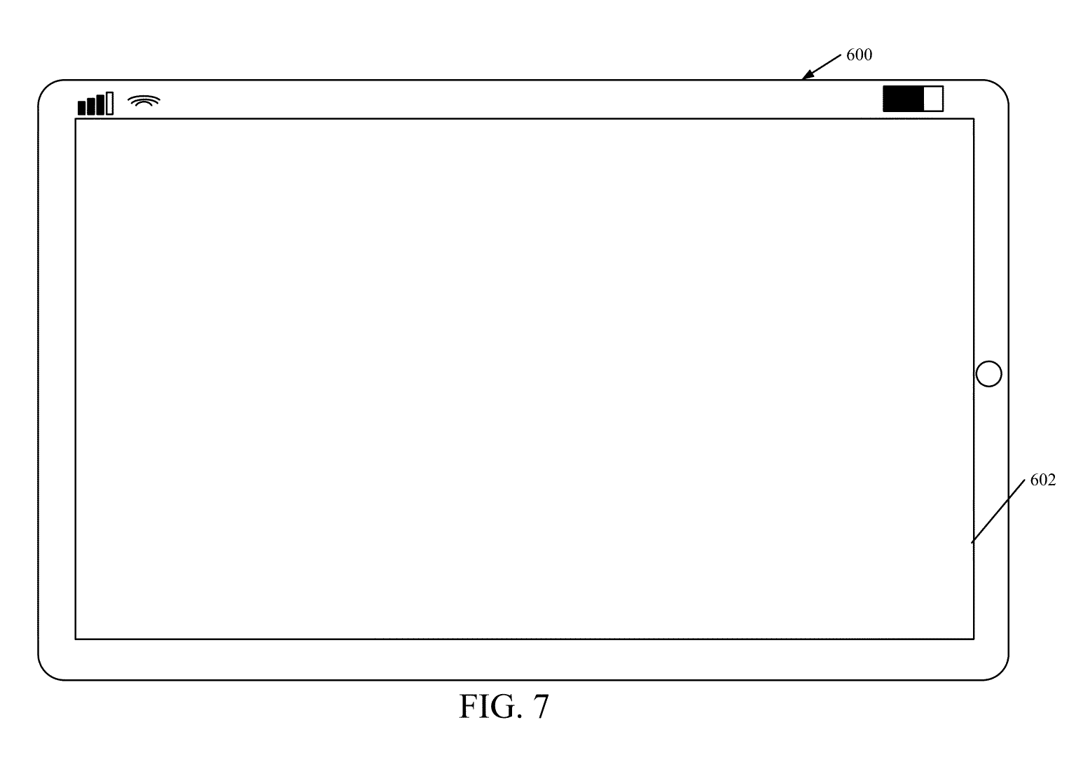

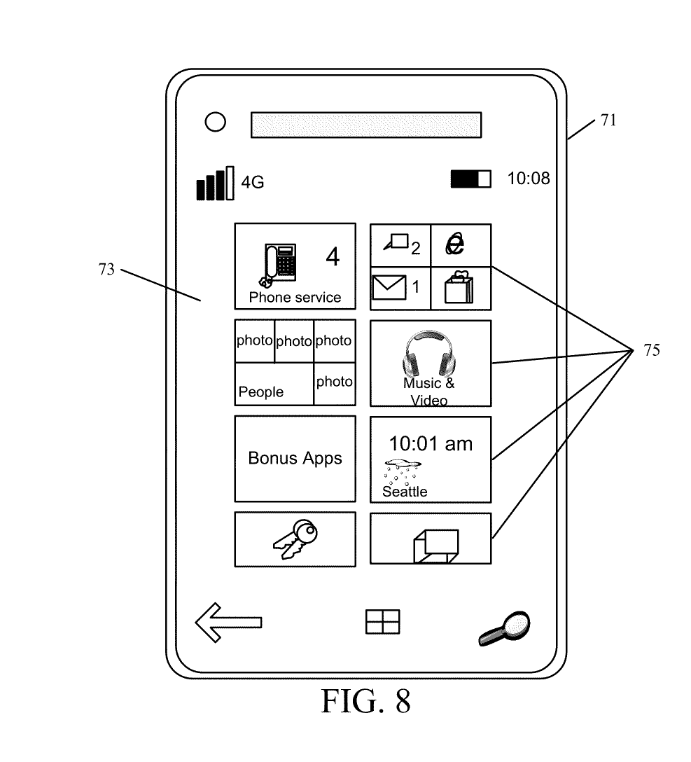

FIG. 6 is a simplified block diagram of one illustrative example of a handheld or mobile computing device 16 that can be used as a user's or client's hand held device or mobile device 102 or 114. FIGS. 7-8 are examples of handheld or mobile devices.

FIG. 6 provides a general block diagram of the components of a client device 16 that can run components of the architectures discussed above or that interacts with those architectures, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 132 or 152 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. All of the items in mobile devices 102-114 discussed with respect to the above features are not shown in FIG. 5. It will be noted that those items can illustratively be included as well. Similarly, device 16 can have a client system 24 which can run various applications or embody parts or all of the applications used to make the presentation. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one example in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some embodiments, the phone also includes a Secure Digital (SD) card slot that accepts a SD card.

The mobile device can also be a personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. Although not shown, the PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows that the device can be a smart phone 71. Smart phone 71 can have a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

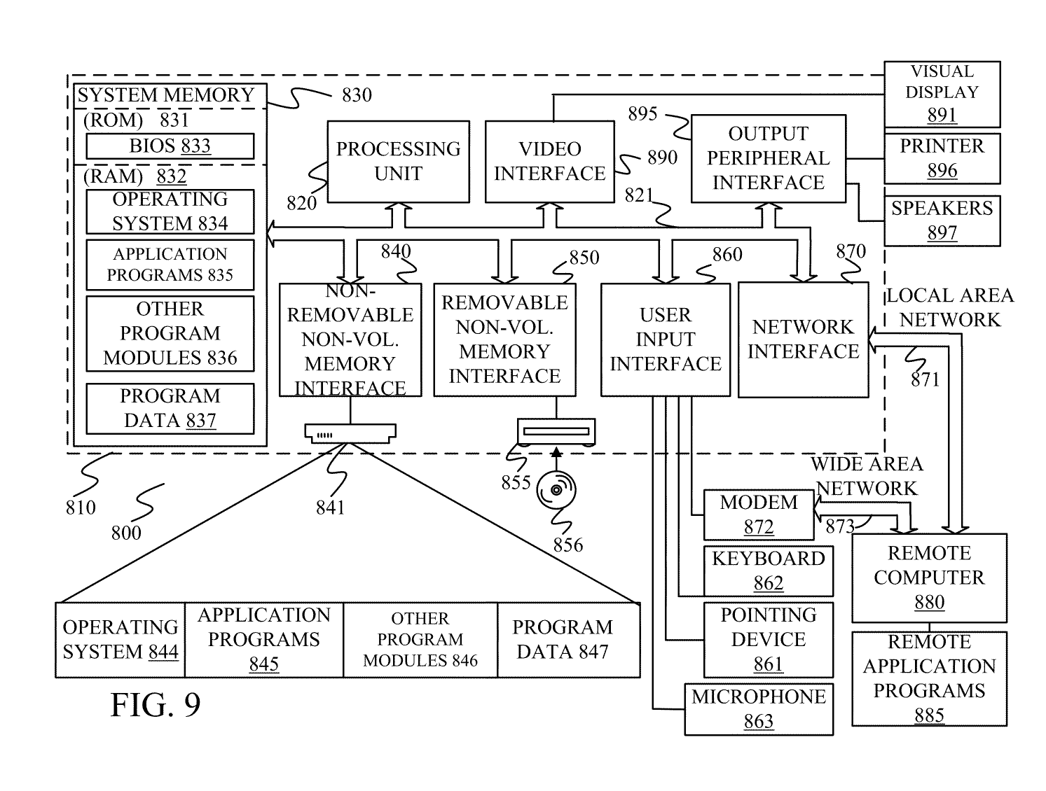

FIG. 9 is one example of a computing environment in which the architectures discussed above, or parts of them, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 132, 152 or 216), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a mobile device, comprising:

a sharing system that sends a request to join a presentation to a presenting mobile device and that receives extracted content from the presenting mobile device, the extracted content being in a form in which accessibility settings can be applied to the extracted content;

an accessibility system that applies the accessibility settings to the extracted content to obtain accessibility content; and

a display device that displays the accessibility content.

Example 2 is the mobile device of any or all previous examples and further comprising:

an application component that runs an application to present a document.

Example 3 is the mobile device of any or all previous examples wherein the application component receives presentation control commands from the presenting mobile device, the application component controlling the accessibility content displayed on the display device of the mobile device based on the control commands.

Example 4 is the mobile device of any or all previous examples wherein the application component controls the accessibility content displayed on the display device of the mobile device based on the control commands so that the displayed accessibility content mirrors the presentation, except that the accessibility content has the accessibility settings applied to it.

Example 5 is the mobile device of any or all previous examples wherein the sharing system sends the request and receives the extracted content over an ad-hoc network.

Example 6 is a computing system, comprising:

a content sharing system that receives, from a requesting mobile device, a request to join a presentation controlled by a presenting mobile device and that obtains presentation content for the presentation; and

an accessibility system that applies user accessibility settings to the presentation content to obtain accessibility content, the sharing system sending the accessibility content to the requesting mobile device.

Example 7 is the computing system of any or all previous examples wherein the content sharing system obtains the user accessibility settings from the requesting mobile device.

Example 8 is the computing system of any or all previous examples wherein the content sharing system comprises:

a user identifier that obtains user identifying information from the request to join the presentation.

Example 9 is the computing system of any or all previous examples wherein the content sharing system comprises:

an accessibility setting identifier that identifies the accessibility settings based on the user identifying information.

Example 10 is the computing system of any or all previous examples and further comprising:

a user/setting map that maps user identifying information to the accessibility settings, the accessibility setting identifier identifying the accessibility settings by accessing the user/setting map based on the user identifying information.

Example 11 is the computing system of any or all previous examples wherein the accessibility system applies a plurality of different sets of user accessibility settings to the presentation content to generate a plurality of different versions of accessibility content.

Example 12 is the computing system of any or all previous examples wherein the content sharing system comprises:

a version identifier that identifies a given version, of the plurality of different versions of accessibility content, based on the user identifying information.

Example 13 is the computing system of any or all previous examples and further comprising:

a user/version map that maps user identifying information to the different versions of the accessibility content, the version identifier identifying the given version by accessing the user/version map based on the user identifying information.

Example 14 is the computing system of any or all previous examples wherein the accessibility system generates the accessibility content during runtime of the presentation.

Example 15 is the computing system of any or all previous examples wherein the content sharing system receives presentation control commands from the presenting mobile device and sends the presentation control commands to the requesting mobile device.

Example 16 is a mobile device, comprising:

an application component that runs an application to present a document on a presentation device;

a remote control system that generates presentation control user input mechanisms that are actuated to control the presentation on the presentation device;

a content extraction component that extracts content from the presentation in a form in which accessibility settings can be applied to the content; and

a sharing system that receives a request to join the presentation from a receiving mobile device and shares the extracted content with the receiving mobile device.

Example 17 is the mobile device of any or all previous examples wherein the remote control system generates control command signals indicative of actuation of the control user input mechanisms and wherein the remote control system sends the control command signals to the receiving mobile device.

Example 18 is the mobile device of any or all previous examples wherein the sharing system sends the extracted content and the control commands to the receiving mobile device over an ad-hoc network.

Example 19 is the mobile device of any or all previous examples wherein the sharing system shares the extracted content with the requesting mobile device by sending it to a remote service over a wide area network.

Example 20 is the mobile device of any or all previous examples wherein the sharing system sends the extracted content, for the entire document, to the remote service, prior to beginning the presentation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile device, comprising:
a sharing system that sends a request to join a presentation to a presenting mobile device and that receives extracted content from the presenting mobile device, the extracted content being in a form in which accessibility settings can be applied to the extracted content;
an accessibility system that applies the accessibility settings to the extracted content to obtain accessibility content; and
a display device that displays the accessibility content.

2. The mobile device of claim 1 and further comprising:
an application component that runs an application to present a document.

3. The mobile device of claim 2 wherein the application component receives presentation control commands from the presenting mobile device, the application component controlling the accessibility content displayed on the display device of the mobile device based on the control commands.

4. The mobile device of claim 3 wherein the application component controls the accessibility content displayed on the display device of the mobile device based on the control commands so that the displayed accessibility content mirrors the presentation, except that the accessibility content has the accessibility settings applied to it.

5. The mobile device of claim 4 wherein the sharing system sends the request and receives the extracted content over an ad-hoc network.

6. A computing system, comprising:
a content sharing system that receives, from a requesting mobile device, a request to join a presentation controlled by a presenting mobile device and that obtains presentation content for the presentation; and
an accessibility system that applies user accessibility settings to the presentation content to obtain accessibility content, the sharing system sending the accessibility content to the requesting mobile device.

7. The computing system of claim 6 wherein the content sharing system obtains the user accessibility settings from the requesting mobile device.

8. The computing system of claim 7 wherein the content sharing system comprises:
a user identifier that obtains user identifying information from the request to join the presentation.

9. The computing system of claim 8 wherein the content sharing system comprises:
an accessibility setting identifier that identifies the accessibility settings based on the user identifying information.

10. The computing system of claim 9 and further comprising:
a user/setting map that maps user identifying information to the accessibility settings, the accessibility setting identifier identifying the accessibility settings by accessing the user/setting map based on the user identifying information.

11. The computing system of claim 8 wherein the accessibility system applies a plurality of different sets of user accessibility settings to the presentation content to generate a plurality of different versions of accessibility content.

12. The computing system of claim 11 wherein the content sharing system comprises:
a version identifier that identifies a given version, of the plurality of different versions of accessibility content, based on the user identifying information.

13. The computing system of claim 12 and further comprising:
a user/version map that maps user identifying information to the different versions of the accessibility content, the version identifier identifying the given version by accessing the user/version map based on the user identifying information.

14. The computing system of claim 6 wherein the accessibility system generates the accessibility content during runtime of the presentation.

15. The computing system of claim 6 wherein the content sharing system receives presentation control commands from the presenting mobile device and sends the presentation control commands to the requesting mobile device.

16. A mobile device, comprising:
an application component that runs an application to present a document on a presentation device;
a remote control system that generates presentation control user input mechanisms that are actuated to control the presentation on the presentation device;
a content extraction component that extracts content from the presentation in a form in which accessibility settings can be applied to the content; and
a sharing system that receives a request to join the presentation from a receiving mobile device and shares the extracted content with the receiving mobile device.

17. The mobile device of claim 16 wherein the remote control system generates control command signals indicative of actuation of the control user input mechanisms and wherein the remote control system sends the control command signals to the receiving mobile device.

18. The mobile device of claim 17 wherein the sharing system sends the extracted content and the control commands to the receiving mobile device over an ad-hoc network.

19. The mobile device of claim 17 wherein the sharing system shares the extracted content with the requesting mobile device by sending it to a remote service over a wide area network.

20. The mobile device of claim 19 wherein the sharing system sends the extracted content, for the entire document, to the remote service, prior to beginning the presentation.
